(19) United States
(12) Patent Application Publication
(10) Pub. No.: US 2010/0053190 A1
(43) Pub. Date: Mar. 4, 2010

(54) Method and Apparatus for Signal Compensation in an Image Display Device

(76) Inventors: Chih-Chia Kuo, Hsinchu County (TW); Mei-Fei Chen, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/271,935

(22) Filed: Nov. 17, 2008

(30) Foreign Application Priority Data
Aug. 29, 2008 (TW) 097133207

(51) Int. Cl. G09G 5/02

(52) U.S. Cl. 345/589

(57) ABSTRACT

A signal compensation method for an image display device includes deriving an input signal, which is a product of an original signal and a gain value, comparing the input signal with a threshold range for generating a comparison result, generating a difference value according to the comparison result, and generating an output signal according to the original signal, the difference value and a weighting value.

### BACKGROUND OF THE INVENTION

1. Field of the Invention

The present invention relates to a signal compensation method and related device for an image display device, and more particularly, to a signal compensation method and related device for generating a compensated output signal of the image display device according to a gain value.

2. Description of the Prior Art

When a user of an image display device, e.g. a television, a computer or a DVD player, wants to adjust proportion, color saturation or brightness of a displayed image, the image display device usually has to amplify a received signal of the displayed image before outputting the displayed image to meet the demands of the user.

Generally, an output signal of the image display device is limited to an allowable range. If an amplified signal (which is the received signal after amplification) exceeds the allowable range of the output signal, the output signal will not be equal to the amplified signal but is clamped to a boundary of the allowable range of the output signal, and therefore the resolution of the displayed image is decreased. In order to avoid the resolution being lost, the image display device uses a conventional method that defines several predefined values of the output signal corresponding to specific values of the amplified signal, and uses interpolation to find the corresponding output signal according to the predefined values of the output signal. The image display device also uses another conventional method that obtains the proper output signal according to a look-up table storing a boundary curve of the output signal. When the amplified signal exceeds the boundary, the output signal will be limited to the boundary.

However, the implementation of the interpolation method requires more software resources and the implementation of the look-up table requires more hardware resources, which cannot reduce production cost.

### SUMMARY OF THE INVENTION

It is therefore a primary objective of the claimed invention to provide a signal compensation method and related device for an image display device.

The present invention discloses a signal compensation method for an image display device. The signal compensation method comprises deriving an input signal, which is a product of an original signal and a gain value, comparing the input signal with a threshold range for generating a comparison result, generating a difference value according to the comparison result, and generating an output signal according to the original signal, the difference value and a weighting value.

The present invention further discloses a signal compensation device for an image display device. The signal compensation device comprises a receiving terminal, a first multiplier, a comparator, a multiplexer, a subtractor, a second multiplier and an adder. The receiving terminal is utilized for receiving an original signal. The first multiplier is coupled to the receiving terminal, and is utilized for multiplying the original signal with a gain value for generating an input signal. The comparator is coupled to the first multiplier, and is utilized for comparing the input signal with a threshold range for generating a comparison result. The multiplexer is coupled to the first multiplier and the comparator, and is utilized for outputting a boundary signal according to the comparison result. The subtractor is coupled to the multiplexer and the receiving terminal, and is utilized for subtracting the original signal from the boundary signal for generating a difference value. The second multiplier is coupled to the subtractor, and is utilized for multiplying the difference value and a weighting value for generating a compensation signal. The adder is coupled to the second multiplier and the receiving terminal, and is utilized for adding the compensation signal to the original signal for generating an output signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process according to an embodiment of the present invention.

FIG. 2 is a relationship diagram of all possible values of the output signal to the input signal shown in FIG. 1.

FIG. 3 is a relationship diagram of the output signal of unsigned number to the input signal according to an embodiment of the present invention.

FIG. 4 is a relationship diagram of the output signal of signed number to the input signal according to an embodiment of the present invention.

FIG. 5 is a diagram of relationship between weighting values and the input signal according to an embodiment of the present invention.

FIG. 6 and FIG. 7 are schematic diagrams of signal compensation devices according to embodiments of the present invention.

### DETAILED DESCRIPTION

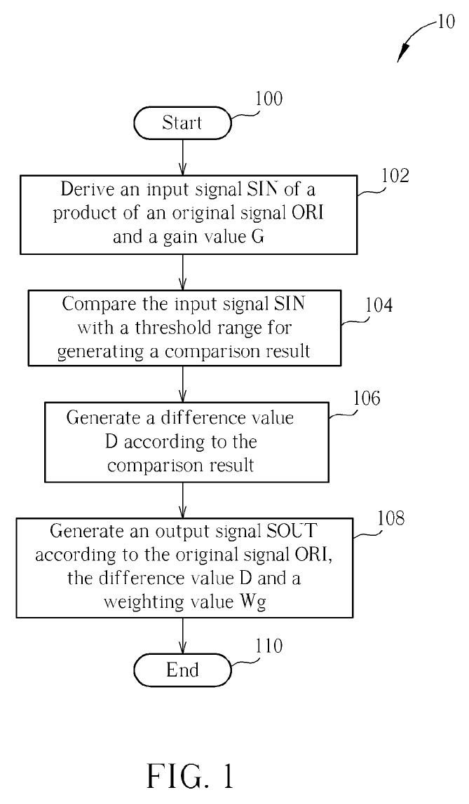

Please refer to FIG. 1, which is a flowchart of a process 10 according to an embodiment of the present invention. The process 10 is utilized in an image display device such as a computer, a television or a multimedia player, for generating a compensated output signal of the image display device for avoiding the resolution being lost occurring on the displayed image. The process 10 comprises the following steps:

Step 100: Start.

Step 102: Derive an input signal SIN, which is a product of an original signal ORI and a gain value G.

Step 104: Compare the input signal SIN with a threshold range for generating a comparison result.

Step 106: Generate a difference value D according to the comparison result.

Step 108: Generate an output signal SOUT according to the original signal ORI, the difference value D and a weighting value Wg.

Step 110: End.

In the process 10, the original signal ORI is a received signal of the image display device, and the product of the original signal ORI and the gain value G is defined as the input signal SIN. In the prior art, the input signal SIN is directly equal to the output signal SOUT that generates the displayed image of the image display device, and the resolution being lost may occur because the output signal SOUT is clamped as a result of the limitation of the image display device. In comparison, the process 10 performs signal compensation on the input signal SIN and then generates the output signal SOUT, and the resolution being lost is improved.

In Step 104 and Step 106, after the image display device derives the input signal SIN, the embodiment of the present invention compares the input signal SIN with the threshold range to generate the comparison result and generates the difference value D accordingly. The threshold range is a range in which the output signal SOUT is outputted without distortion. The threshold range is dependent upon the original signal ORI being an unsigned number or a signed number. The process 10 is described separately by the original signal ORI being an unsigned number and being a signed number as follows.

When the process 10 is performed on the original signal ORI of an unsigned number, e.g. a luminance signal, the lower bound and the upper bound of the threshold range are 0 and UPPER, respectively. In this situation, Step 106 comprises two cases. The first is that when the comparison result indicates that the input signal SIN is larger than the upper bound UPPER, the difference value D is a result of subtracting the original signal ORI from the upper bound UPPER. The second is that when the comparison result indicates that the input signal SIN is in the threshold range 0 to UPPER, the difference value D is a result of subtracting the original signal ORI from the input signal SIN. Next, in Step 108, the image display device generates the output signal SOUT according to the original signal ORI, the difference value D and the weighting value Wg. Precisely, the output signal SOUT is a summation of the original signal ORI and the product of the difference value D and the weighting value Wg. The weighting value Wg is a fixed value set between 0% to 100%. From the above, the generation of the output signal SOUT of unsigned number is summarized as the following equations:

when SIN>UPPER, SOUT=ORI+(UPPER−ORI)×Wg (1)

when SIN≦UPPER, SOUT=ORI+(SIN−ORI)×Wg (2)

When the process 10 is performed on the original signal ORI of a signed number, e.g. a color saturation signal of (Cb,Cr), the lower bound and the upper bound of the threshold range are (−UPPER) and UPPER, respectively. In this situation, Step 106 comprises three cases. The first is that when the comparison result indicates that the input signal SIN is larger than the upper bound UPPER, the difference value D is a result of subtracting the original signal ORI from the upper bound UPPER. The second is that when the comparison result indicates that the input signal SIN is smaller that the lower bound (−UPPER), the difference value D is a result of subtracting the original signal ORI from the lower bound (−UPPER). The third is that when the comparison result indicates that the input signal SIN is in the threshold range (−UPPER) to UPPER, the difference value D is a result of subtracting the original signal ORI from the input signal SIN. The output signal SOUT is a summation of the original signal ORI and the product of the difference value D and the weighting value Wg. From the above, the generation of the output signal SOUT of signed number is summarized as the following equations:

when SIN>UPPER, SOUT=ORI+(UPPER−ORI)×Wg (3)

when SIN<(−UPPER), SOUT=ORI+(−UPPER−ORI)×Wg (4)

when (−UPPER)≦SIN≦UPPER, SOUT=ORI+(SIN−ORI)×Wg (5)

In the prior art, the output signal SOUT of the image display device is directly equal to the input signal SIN of the product of the original signal ORI and the gain value G without any further compensation. As a result, when the output signal SOUT exceeds the upper/lower bound of the threshold range, the output signal SOUT is clamped to the upper/lower bound and results in the resolution being lost. In comparison, the embodiment of the present invention generates the difference value D according to the comparison result of comparing the input signal SIN with the threshold range, and further generates the output signal SOUT according to the original signal ORI, the difference value D and the weighting value Wg. Therefore, the embodiment of the present invention prevents the output signal SOUT from exceeding the threshold range that results in the resolution being lost.

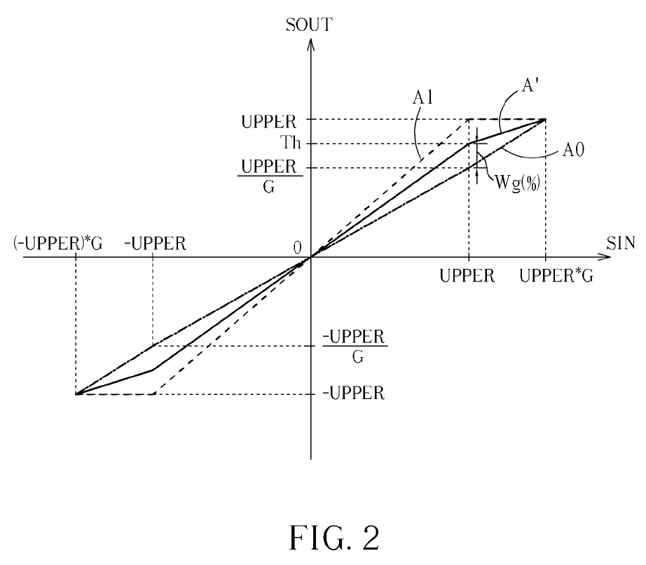

Please refer to FIG. 2, which is a relationship diagram of all possible values of the output signal SOUT to the input signal SIN. The whole FIG. 2 illustrates the output signal SOUT of signed number, and the first quadrant of FIG. 2 also illustrates the output signal SOUT of unsigned number. In FIG. 2, a curve A0 shows that the output signal SOUT is equal to the original signal ORI, and a curve A1 shows that the output signal SOUT is equal to the input signal SIN. Please note that, the idea of the present invention is based on deriving a curve A′ between A0 and A1, which is not clamped by the boundary of the threshold range. In addition, when the gain value G changes in accordance with the input signal SIN, the embodiment of the present invention dynamically compensates the input signal SIN to generate the compensated output signal SOUT according to the weighting value Wg. According to the curves A0, A1 and A′ in FIG. 2, the equations (1) and (2) are derived as follows:

$$\begin{matrix}Th = \frac{UPPER}{G} \times ( 1 - Wg ) + UPPER \times Wg \\ = UPPER \times ( \frac{1 + ( G - 1 ) \times Wg}{G} )\end{matrix}$$

$$Let A = G - 1 , \\ Th \times G = UPPER \times ( 1 + A \times Wg )$$

$$S IN = G \times ORI = ( A + 1 ) \times ORI$$

$$If ( S IN > UPPER ) , \\ SOUT$$

Derivation of equation (3), (4) and (5) is similar to that of equations (1) and (2), and is not given here.

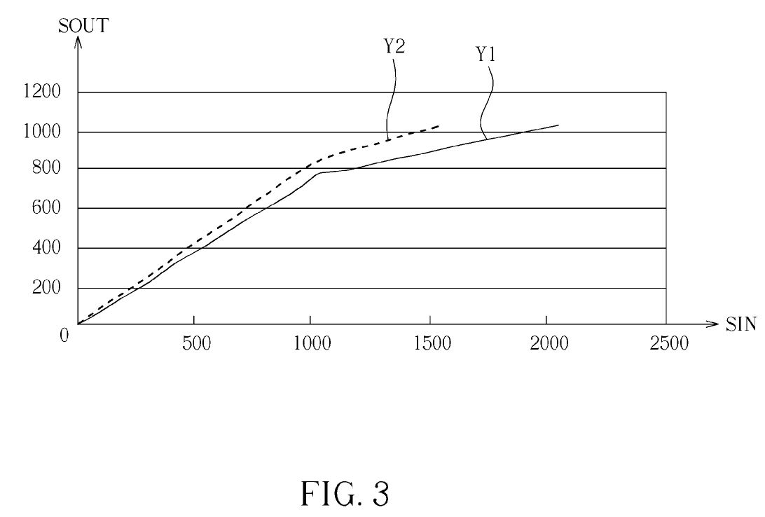

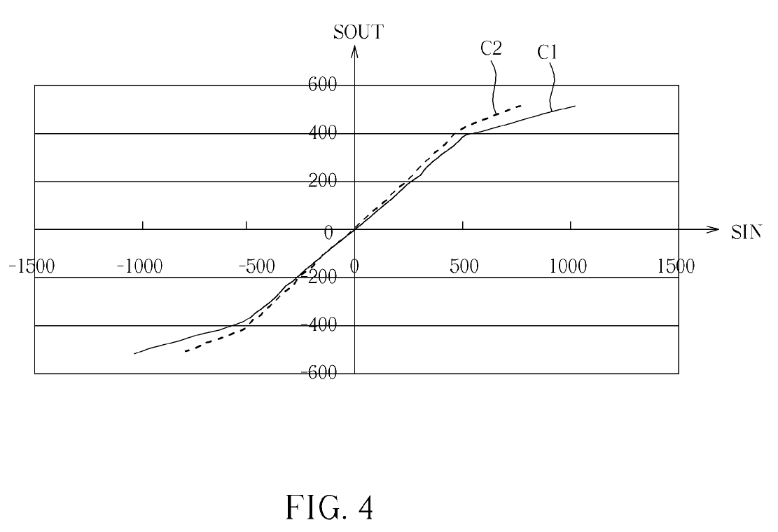

Please refer to FIG. 3, which is a relationship diagram of the output signal SOUT of unsigned number to the input signal SIN according to an embodiment of the present invention. In FIG. 3, a range of the original signal ORI is from 0 to 1023, the upper bound UPPER of the threshold range is 1023, the weighting value Wg is 0.5, curve Y1 is the output signal SOUT with the gain value 2, and curve Y2 is the output signal SOUT with the gain value 1.5. Please refer to FIG. 4, which is a relationship diagram of the output signal SOUT of signed number to the input signal SIN according to an embodiment of the present invention. In FIG. 4, a range of the original signal ORI is from −512 to 512, the upper bound UPPER and the lower bound (−UPPER) of the threshold range are 512 and −512 respectively, the weighting value Wg is 0.5, curve C1 is the output signal SOUT with the gain value 2, and curve C2 is the output signal SOUT with the gain value 1.5. From the above FIG. 3 and FIG. 4, it is known that when the gain value G changes in accordance with the input signal SIN, the embodiment of the present invention dynamically compensates the input signal SIN to generate the compensated output signal SOUT according to the weighting value Wg.

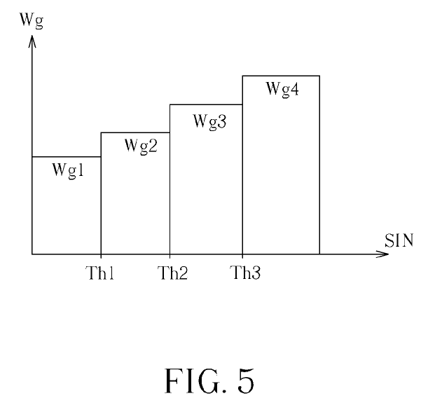

Please note that, FIG. 2, FIG. 3 and FIG. 4 are embodiments of the present invention, and those skilled in the art can make alterations and modifications accordingly. For example, the output signal SOUT can be generated according to different weighting values instead of a single fixed weighting value as in FIG. 2 to FIG. 4. Please refer to FIG. 5, which is a diagram illustrating relationship between weighting values and the input signal SIN according to an embodiment of the present invention. The main idea is to select a weighting value from several different weighting values according to which range the input signal SIN belongs to. As a result, the curve of the output signal SOUT approaches the threshold range smoothly and is not clamped.

Take weighting values shown in FIG. 5 as an example. The overall range of the input signal SIN is divided into four sub-ranges by threshold values Th1, Th2 and Th3. The four sub-ranges of the input signal SIN corresponds to four weighting values Wg1 to Wg4, respectively. Let Th1=UPPER/2, Th2=UPPER and Th3=UPPER×(1+G)/2, wherein UPPER is the upper bound of the threshold range of the output signal SOUT. According to FIG. 5, all possible output signal SOUT are divided into four sub-ranges as follows:

If (0≦SIN<Th1),

SOUT=ORI+(SIN−ORI)×Wg1 (6)

If (Th1≦SIN<Th2),

SOUT=ORI+(SIN−ORI)×Wg2 (7)

If (Th2≦SIN<Th3),

SOUT=ORI+(UPPPER−ORI)×Wg3 (8)

If (Th3≦SIN),

SOUT=ORI+(UPPPER−ORI)×Wg4 (9)

Derivation of equations (6), (7), (8) and (9) is similar to that of equations (1) and (2), and is not given here.

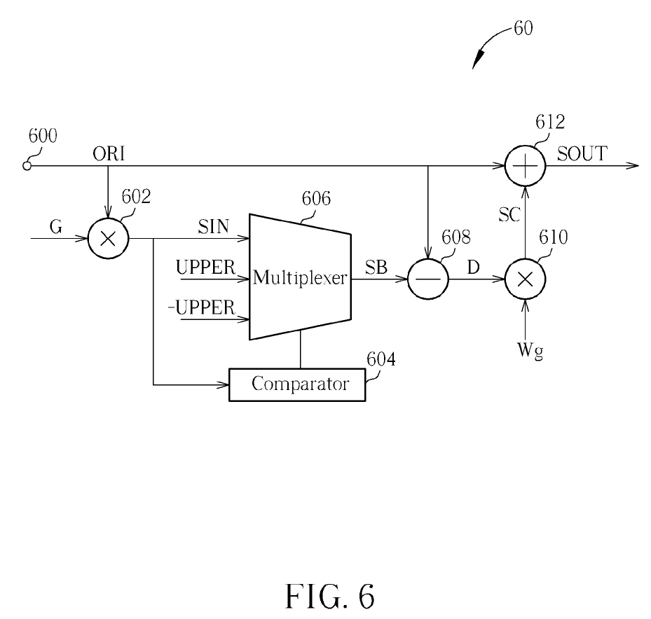

Please refer to FIG. 6, which is a schematic diagram of a signal compensation device 60 according to an embodiment of the present invention. The signal compensation device 60 is a hardware implementation of the process 10 and is utilized in the image display device, for performing signal compensation for preventing the resolution from being lost in the output signal SOUT. The signal compensation device 60 comprises a receiving terminal 600, a multiplier 602, a comparator 604, a multiplexer 606, a subtractor 608, a multiplier 610 and an adder 612. The receiving terminal 600 is utilized for receiving the original signal ORI. The multiplier 602 is coupled to the receiving terminal 600 and is utilized for multiplying the original signal ORI with the gain value G, for generating the input signal SIN. The comparator 604 is coupled to the multiplier 602, and is utilized for comparing the input signal SIN with the threshold range for generating the comparison result. The multiplexer 606 is coupled to the multiplier 602 and the comparator 604, and is utilized for outputting a boundary signal SB according to the comparison result. When the comparison result indicates that the input signal SIN is larger than the upper bound UPPER of the threshold range, smaller than the lower bound (−UPPER) of the threshold range or exactly in the threshold range, the boundary signal SB is respectively equal to the upper bound UPPER, the lower bound (−UPPER) or the input signal SIN.

The subtractor 608 is coupled to the multiplexer 606 and the receiving terminal 600, and is utilized for subtracting the original signal ORI from the boundary signal SB for generating the difference value D. The comparator 604, the multiplexer 606 and the subtractor 608 are utilized for performing Step 104 and Step 106 of the process 10, which is detailed described previously and are not repeated here. The multiplier 610 is coupled to the subtractor 608 and is utilized for multiplying the difference value D and the weighting value Wg for generating a compensation signal SC. The adder 612 is coupled to the multiplier 610 and the receiving terminal 600, and is utilized for adding the compensation signal SC to the original signal ORI for generating the output signal SOUT. The multiplier 610 and the adder 612 are utilized for performing Step 108 of the process 10.

Please note that, the embodiments of the present invention can be applied in whether the original signal ORI is an unsigned number or a signed number. In FIG. 6, the signal compensation device 60 is utilized for signal compensation of signed number, and therefore the comparator 604 and the multiplexer 606 operates according to the threshold range of the signed number. In another embodiment of the present invention, the comparator 604 and the multiplexer 606 can also operate according to the threshold range of the unsigned number. The conventional method of interpolation or look-up table requires higher production cost to accomplish signal compensation. In comparison, the signal compensation device 60 performs signal compensation via simple components, such as a comparator and a multiplier, so that production cost of the image display device is reduced.

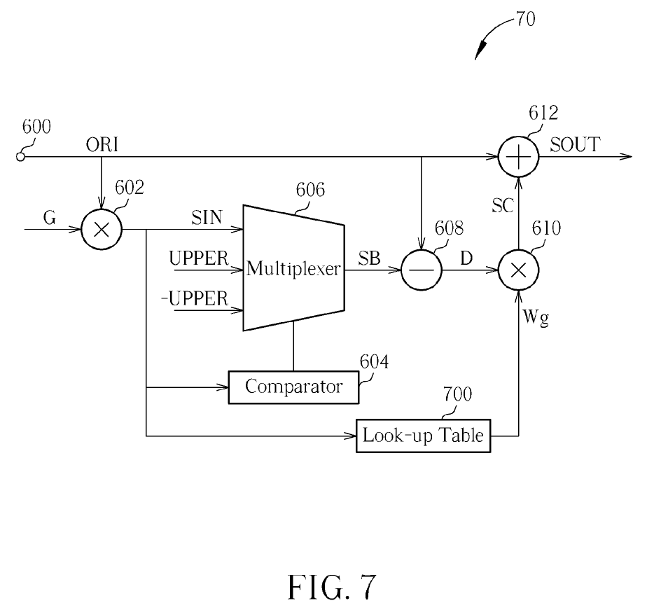

In addition, please refer to FIG. 7, which is a schematic diagram of a signal compensation device 70 according to an embodiment of the present invention. The signal compensation device 70 comprises all units in the signal compensation device 60 and further comprises a look-up table 700 storing a plurality of weighting values. The look-up table 700 is coupled to the multiplier 602 and the multiplier 610, and is utilized for outputting one of the plurality of weighting values according to the input signal SIN (which belongs to a range). As a result, the signal compensation device 70 generates the output signal SOUT according to the plurality of weighting values.

In conclusion, the embodiment of the present invention generates the output signal of the image display device according to the original signal, the difference value and the weighting value, which is easy to be implemented. Therefore, the resolution being lost of the output signal is improved and production cost is reduced.

Those skilled in the art will readily observe that numerous modifications and alterations of the device and method may be made while retaining the teachings of the invention.

What is claimed is:

1. A signal compensation method for an image display device, the signal compensation method comprising:
deriving an input signal, which is a product of an original signal and a gain value;
comparing the input signal with a threshold range for generating a comparison result;
generating a difference value according to the comparison result; and
generating an output signal according to the original signal, the difference value and a weighting value.

2. The signal compensation method of claim 1, wherein the step of generating the difference value comprises when the comparison result indicates that the input signal is larger than an upper bound of the threshold range, subtracting the original signal from the upper bound of the threshold range for generating the difference value.

3. The signal compensation method of claim 1, wherein the step of generating the difference value comprises when the comparison result indicates that the input signal is in the threshold range, subtracting the original signal from the input signal for generating the difference value.

4. The signal compensation method of claim 1, wherein the step of generating the difference value comprises when the comparison result indicates that the input signal is smaller than a lower bound of the threshold range, subtracting the original signal from the lower bound of the threshold range for generating the difference value.

5. The signal compensation method of claim 1, wherein the step of generating the output signal comprises adding a product of the difference value and the weighting value to the original signal for generating the output signal.

6. The signal compensation method of claim 1, wherein the weighting value is a fixed value.

7. The signal compensation method of claim 1, wherein the weighting value is selected from a plurality of weighting values according to the input signal.

8. The signal compensation method of claim 1, wherein the threshold range is a range of the output signal without distortion.

9. The signal compensation method of claim 1, wherein the original signal is a luminance signal or a color saturation signal.

10. A signal compensation device for an image display device, the signal compensation device comprising:
a receiving terminal for receiving an original signal;
a first multiplier coupled to the receiving terminal, for multiplying the original signal with a gain value for generating an input signal;
a comparator coupled to the first multiplier, for comparing the input signal with a threshold range for generating a comparison result;
a multiplexer coupled to the first multiplier and the comparator, for outputting a boundary signal according to the comparison result;
a subtractor coupled to the multiplexer and the receiving terminal, for subtracting the original signal from the boundary signal for generating a difference value;
a second multiplier coupled to the subtractor, for multiplying the difference value and a weighting value for generating a compensation signal; and
an adder coupled to the second multiplier and the receiving terminal, for adding the compensation signal to the original signal for generating an output signal.

11. The signal compensation device of claim 10, wherein when the comparison result indicates that the input signal is larger than an upper bound of the threshold range, the boundary signal outputted by the multiplexer is equal to the upper bound of the threshold range.

12. The signal compensation device of claim 10, wherein when the comparison result indicates that the input signal is in the threshold range, the boundary signal outputted by the multiplexer is equal to the input signal.

13. The signal compensation device of claim 10, wherein when the comparison result indicates that the input signal is smaller than a lower bound of the threshold range, the boundary signal outputted by the multiplexer is equal to the lower bound of the threshold range.

14. The signal compensation device of claim 10, wherein the weighting value is a fixed value.

15. The signal compensation device of claim 10 further comprising a look-up table coupled to the first multiplier and the second multiplier, for storing a plurality of weighting values and outputting one of the plurality of weighting values according to the input signal.

16. The signal compensation device of claim 10, wherein the threshold range is a range of the output signal without distortion.

17. The signal compensation device of claim 10, wherein the original signal is a luminance signal or a color saturation signal.
